(19) United States
(12) Patent Application Publication
(10) Pub. No.: US 2020/0223195 A1
(43) Pub. Date: Jul. 16, 2020

(54) BIDIRECTIONAL ELASTIC AIR-PERMEABLE MATERIAL

(71) Applicant: GOLDEN PHOENIX FIBERWEBS, INC., TAINAN CITY (TW)

(72) Inventors: Kenneth Cheng, Taipei City (TW); Eric Shyuu, Taipei City (TW)

(21) Appl. No.: 16/638,304

(22) PCT Filed: Jan. 29, 2019
(86) PCT No.: PCT/CN2019/073650

§ 371 Date: Feb. 11, 2020

(30) Foreign Application Priority Data
May 25, 2018 (CN) 201810516001.X

(51) Int. Cl. B32B 27/12; B32B 27/32

(52) U.S. Cl. CPC B32B 27/12; B32B 5/022; B32B 27/32

(57) ABSTRACT

A bidirectional elastic air-permeable material, including: a unidirectional elastic cloth (10) having a plurality of penetrating air vents (12) and a weft-direction stretchability; and a bidirectional elastic film (20) constituted of a thermoplastic elastomer material, having also a plurality of penetrating air vents (22) and proper stretchability in both weft and warp directions; wherein an upper surface of the bidirectional elastic film (20) is entirely or partially adhered to a lower surface of the unidirectional elastic cloth (10). In particular, the bidirectional elastic film (20) has an air permeability of 17-25 cc/sec per square centimeter, and the bidirectional elastic air-permeable material has an overall air permeability of 7-10 cc/sec per square centimeter. The bidirectional elastic air-permeable material has the advantages of bidirectional stretchability and air permeability and is suitable for applying to close-fitting clothing or diapers to improve comfort and prevent sultriness and moisture.

### CROSS-REFERENCE TO RELATED APPLICATION

This application claims the benefit as a national stage entry of the international application PCT/CN2019/073650 with an international filing date of Jan. 29, 2019, which claims the priority of Chinese patent application No. 201810516001.X, filed on May 25, 2018, which is incorporated herewith by reference.

### BACKGROUND OF THE INVENTION

### 1. Field of the Invention

The present invention relates to a bidirectional elastic air-permeable material, wherein more particularly, a cloth with at least one-direction elasticity, which has weft-direction stretchability, is adhered to a film with at least two-direction elasticity to realize the characteristics of having strong bidirectional resilience and high air permeability.

### 2. The Prior Arts

When considering hygiene and using safety, general sanitary products, such as masks, disposable clothing, baby diapers or adult diapers, are usually provided in one-time or disposable usage manners to avoid contamination by germs or harmful substances. Since these products are usually in contact with skin for a period of time, the air permeability requirements are stricter to prevent discomfort or allergy, itch, and even rash of the skin caused by sultriness or moisture.

Because the non-woven fabrics made of plastic materials have the advantages of being easy to manufacture, process, excellent chemical resistance, durability and low cost, they have been widely used in many sanitary products. However, non-woven fabrics have poor stretchability, which may cause using inconvenience in applications, such as diapers, which need to be worn. Therefore, the industry has developed a non-woven fabric capable of improving the stretchability, which can be called elastic non-woven fabric.

In related arts, generally, a unidirectional stretching force is applied to the non-woven fabric and then the fiber structure is destroyed. After the original applied force is released, the non-woven fabric naturally recovers and contracts to form a unidirectional elastically-stretched elastic non-woven fabric.

In addition, the industry also further brings up a multi-layered composite structure to enhance the effect of the elastic recovering force. Usually, an elastic film is sandwiched between both elastic non-woven fabrics at upper and lower layers, thereby providing a function similar to elastic ribbons for convenient wearing. However, this related art has the disadvantage that the elastic film itself has a poor air permeability, which significantly reduces the overall air permeability and is unfavorable to the touch feel of the skin.

Therefore, there is a very need for an innovative bidirectional elastic air-permeable material, wherein a unidirectional elastic cloth with weft-direction stretchability is used to be adhered to a bidirectional elastic film to achieve bidirectional elasticity high air permeability. Thus, the bidirectional elastic air-permeable material is suitable for fabricating close-fitting clothing or diapers, thereby solving all the problems of the above-mentioned related arts.

### SUMMARY OF THE INVENTION

The main objective of the present invention is to provide a bidirectional elastic air-permeable material, comprising a unidirectional elastic cloth and a bidirectional elastic film; wherein the unidirectional elastic cloth is constituted of polyethylene, polypropylene, polystyrene, polymethyl methacrylate, polyvinyl chloride, nylon, polycarbonate, polytetrafluoroethylene or polylactic acid, has a plurality of penetrating air vents, and has a stretchability of 150% to 400% in the weft direction. The bidirectional elastic film is constituted of a thermoplastic elastomer material such as TPE-E/S/A, TPO, TPV or TPU and has a plurality of penetrating air vents, and an upper surface of the bidirectional elastic film is entirely or partially adhered to a lower surface of the unidirectional elastic cloth. The bidirectional elastic film has a weft-direction stretchability in the weft direction and a warp-direction stretchability in the warp direction. The weft-direction stretchability and the warp-direction stretchability are 100% to 300%. In particular, the bidirectional elastic film has an air permeability of 17-25 cc/sec per square centimeter, and the bidirectional elastic air-permeable material has an overall air permeability of 7-10 cc/sec per square centimeter. Further, the air vents of the bidirectional elastic film are aligned or misaligned with the air vents of the unidirectional elastic cloth.

The unidirectional elastic cloth only has stretchable resilience in the weft direction, but not in the warp direction, however, the bidirectional elastic film with both weft-directional stretchability and warp-directional stretchability is directly or indirectly adhered to the unidirectional elastic cloth, therefore, the entire bidirectional elastic air-permeable material has highly strong recovering force with respect to the elastic-stretching in both weft and warp directions. In addition, both the unidirectional elastic cloth and the bidirectional elastic film themselves have high air permeability and are quite suitable for applying in fields of close-fitting clothing or diapers to improve comfort and prevent rash or itch caused by sultriness and moisture.

### BRIEF DESCRIPTION OF THE DRAWINGS

FIG. 1 is a schematic view showing a bidirectional elastic air-permeable material according to a first embodiment of the present invention.

FIG. 2 is a schematic view showing a bidirectional elastic air-permeable material according to a second embodiment of the present invention.

FIG. 3 is a schematic view showing a bidirectional elastic air-permeable material according to a third embodiment of the present invention.

Wherein, the reference numerals are described as follows:
10 unidirectional elastic cloth
12 air vent
20 bidirectional elastic film
22 air vent
30 another unidirectional elastic cloth
32 air vent
40 another bidirectional elastic film
42 air vent

### DETAILED DESCRIPTION OF THE PREFERRED EMBODIMENT

Embodiments of the present invention will be described in more detail below with reference to the drawings and the reference numerals, such that those skilled in the art can implement it after studying this specification.

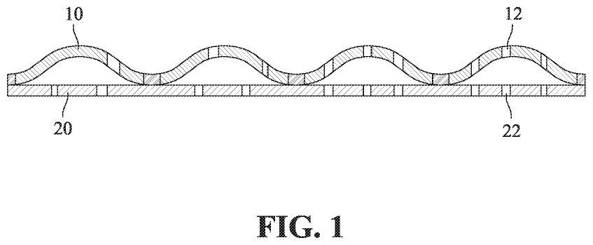

Refer to FIG. 1, which is a schematic view of a bidirectional elastic air-permeable material of a first embodiment of the present invention. As shown in FIG. 1, the bidirectional elastic air-permeable material of the first embodiment of the present invention comprises a unidirectional elastic cloth 10 and a bidirectional elastic film 20, wherein an upper surface of the bidirectional elastic film 20 is entirely or partially adhered to a lower surface of the unidirectional elastic cloth 10, thereby forming a multi-layered structure with bidirectional elasticity. The above-mentioned partial adhering may have various implementations for achieving local dot-shaped adhering, grid-shaped adhering, strip-shaped adhering and the like in matrix arrangements, while FIG. 1 shows an exemplary example of the partial adhering.

Specifically, the unidirectional elastic cloth 10 is constituted of polyethylene (PE), polypropylene (PP), polystyrene (PS), polymethyl methacrylate (PMMA), polyvinyl chloride (PVC), nylon, polycarbonate (PC), polytetrafluoroethylene (PTFE) or polylactic acid (PLA), may be a non-woven fabric, and has a plurality of air vents 12 penetrating an upper surface and the lower surface of the unidirectional elastic cloth 10. In particular, the unidirectional elastic cloth 10 has a stretchability in the weft direction, wherein the stretchability is preferably 150% to 400%.

The above-mentioned bidirectional elastic film 20 is constituted of a thermoplastic elastomer material, such as a thermoplastic polyester (TPE-E), a thermoplastic polystyrenic block (TPE-S), a thermoplastic polyamide (TPE-A), a thermoplastic polyolefin (TPO), a thermoplastic vulcanizate (TPV) or a thermoplastic polyurethane (TPU), and has a plurality of air vents 22 penetrating the upper surface and an lower surface of the bidirectional elastic film 20. The bidirectional elastic film 20 has a weft-direction stretchability in the weft direction and a warp-direction stretchability in the warp direction. The weft-direction stretchability and the warp-direction stretchability are 100% to 300%. In particular, the bidirectional elastic film 20 has an air permeability of 17-25 cc/sec per square centimeter.

Further, the air vents 22 of the bidirectional elastic film 20 can be aligned or misaligned with the air vents 12 of the unidirectional elastic cloth 10, and the entire bidirectional elastic air-permeable material has an air permeability which is specially designed to 7-10 cc/sec per square centimeter.

In addition, the upper surface of the bidirectional elastic film 20 and the lower surface of the unidirectional elastic cloth 10 can be directly adhered into a double-layered structure by ultrasonic fusion or hot-pressing fusion; or can also be adhered by coating an additional adhesive material (not shown) between the bidirectional elastic film 20 and the unidirectional elastic cloth 10, wherein the adhesive material can be styrene/isoprene/styrene (SIS) or styrene/ethylene-butylene/styrene (SEBS). Another way is directly extruding the adhesive material to the unidirectional elastic cloth 10 to form the bidirectional elastic film 20, which can achieve the adhering purpose at the same time.

More specifically, the unidirectional elastic cloth 10 can have a wavy-shape surface with locally-bulging regions, which can significantly increase the surface area and expand the application field; meanwhile, the cotton feel and the thick and firm feel due to the fluffy cloth surface can be enhanced as well.

Next, refer to FIG. 2, which is a schematic view of a bidirectional elastic air-permeable material of a second embodiment of the present invention similar to the first embodiment. The main differences thereof are that the second embodiment further comprises an another unidirectional elastic cloth 30, which is also constituted of polyethylene, polypropylene, polystyrene, polymethyl methacrylate, polyvinyl chloride, nylon, polycarbonate, polytetrafluoroethylene or polylactic acid and has a plurality of penetrating air vents 32; and an upper surface of the another unidirectional elastic cloth 30 is entirely or partially adhered to the lower surface of the bidirectional elastic film 20. Further, the air vents 32 of the another unidirectional elastic cloth 30 are aligned or misaligned with the air vents 22 of the bidirectional elastic film 20. That is, the air vents 32 are under the bidirectional elastic film 20 of the first embodiment.

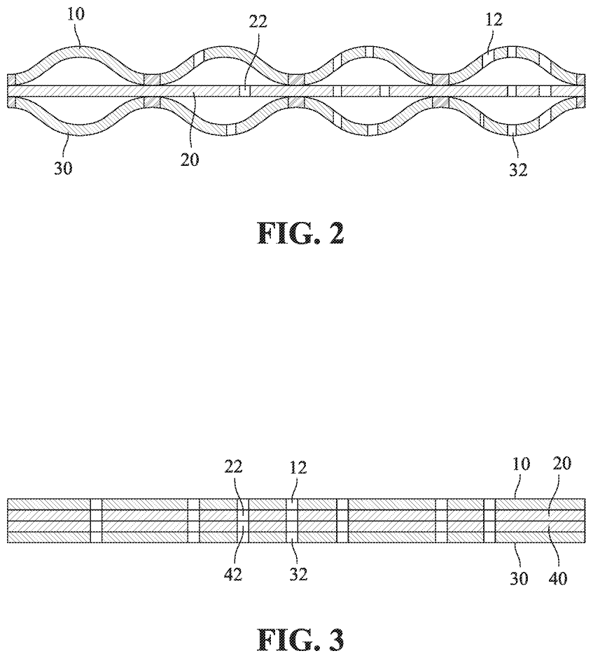

FIG. 3 is a schematic view of a bidirectional elastic air-permeable material of a third embodiment of the present invention similar to the second embodiment. The main difference thereof is that the third embodiment further comprises an another bidirectional elastic film 40, which is also constituted of the thermoplastic elastomer material. A lower surface of the another bidirectional elastic film 40 is entirely or partially adhered to an upper surface of the unidirectional elastic cloth 10, and the another bidirectional elastic film 40 has a plurality of penetrating air vents 42 that can be aligned or misaligned with the air vents 12 of the unidirectional elastic cloth 10. It should be noted that this figure shows an example in which the air vents 12, the air vents 22, the air vents 42, the air vents 32 are aligned with one another; and the unidirectional elastic cloth 10, the bidirectional elastic film 20, the another bidirectional elastic film 40, the another unidirectional elastic cloth 30 are entirely adhered; and thus there is no wave-shaped structure.

The above-mentioned air vents 12, air vents 22, air vents 42, air vents 32 can be formed by the manners of needle piercing, needle punching. For example, by using the pin wheel, because the needle tips on the pin wheel have a high temperature, it can achieve the punching purpose and thus forms the air vents in a circular ring-shape vent arrangement, and can achieve the optimal air permeability by adjusting and changing the vent diameter or the density of arrangement.

In addition, it can also be achieved by hot-pressing punching. First, the entire multi-layered elastic air-permeable material structure is rolled by a set of upper and lower pressing rollers respectively with male and female threads, and the then the punching effect is achieved by high temperature. Next, the surfaces are roll-flattened by a set of smooth-surfaced pressing rollers. Alternatively, the bidirectional elastic films are processed into mesh films with vents in advance before adhered to the unidirectional elastic cloths. Then the bidirectional elastic films are adhered to the unidirectional elastic cloths. Thereby, the air permeability can be improved as well.

In summary, the present invention is characterized in that the unidirectional elastic cloth has resilience only in the weft direction, while the bidirectional elastic film has stretchable resilience both in weft and warp directions. The bidirectional elastic film can be directly or indirectly adhered to the unidirectional elastic cloth, thereby forming an elastic air-permeable material with bidirectional resilience. Particularly, the unidirectional elastic cloth and the bidirectional elastic film have proper air permeability, and thus are quite suitable for applying in fields of close-fitting clothing, diapers, sanitary products to improve hygiene, comfort and prevent rash or itch caused by sultriness and moisture.

The mentioned above are only preferred embodiments for explaining the present invention but intend to limit the present invention in any forms, so that any modifications or verification relating to the present invention made in the same spirit of the invention should still be included in the scope of the invention as intended to be claimed.

What is claimed is:

1. A bidirectional elastic air-permeable material, comprising:
a unidirectional elastic cloth having a plurality of penetrating air vents and constituted of polyethylene (PE), polypropylene (PP), polystyrene (PS), polymethyl methacrylate (PMMA), polyvinyl chloride (PVC), nylon, polycarbonate (PC), polytetrafluoroethylene (PTFE) or polylactic acid (PLA); the unidirectional elastic cloth has a stretchability of 150% to 400% in a weft direction; and
a bidirectional elastic film constituted of a thermoplastic elastomer material and having a plurality of penetrating air vents; the bidirectional elastic film has a weft-direction stretchability in the weft direction and a warp-direction stretchability in a warp direction, the weft-direction stretchability and the warp-direction stretchability are 100% to 300%; and an upper surface of the bidirectional elastic film is entirely or partially adhered to a lower surface of the unidirectional elastic cloth;
wherein, the bidirectional elastic film has an air permeability of 17-25 cc/sec per square centimeter; the air vents of the bidirectional elastic film are aligned or misaligned with the air vents of the unidirectional elastic cloth; and the bidirectional elastic air-permeable material has an air permeability of 7-10 cc/sec per square centimeter.

2. The bidirectional elastic air-permeable material according to claim 1, wherein the thermoplastic elastomer material is a thermoplastic polyester (TPE-E), a thermoplastic polystyrenic block (TPE-S), a thermoplastic polyamide (TPE-A), a thermoplastic polyolefin (TPO), a thermoplastic vulcanizate (TPV) or a thermoplastic polyurethane (TPU).

3. The bidirectional elastic air-permeable material according to claim 1, wherein the upper surface of the bidirectional elastic film and the lower surface of the unidirectional elastic cloth are adhered by an adhesive material, and the adhesive material is styrene/isoprene/styrene (SIS) or styrene/ethylene-butylene/styrene (SEBS).

4. The bidirectional elastic air-permeable material according to claim 1, further comprising an another unidirectional elastic cloth, wherein an upper surface of the another unidirectional elastic cloth is entirely or partially adhered to a lower surface of the bidirectional elastic film; and the another unidirectional elastic cloth is constituted of polyethylene, polypropylene, polystyrene, polymethyl methacrylate, polyvinyl chloride, nylon, polycarbonate, polytetrafluoroethylene or polylactic acid and has a plurality of penetrating air vents aligned or misaligned with the air vents of the bidirectional elastic film.

5. The bidirectional elastic air-permeable material according to claim 4, further comprising an another bidirectional elastic film, wherein a lower surface of the another bidirectional elastic film is entirely or partially adhered to an upper surface of the unidirectional elastic cloth; and the another bidirectional elastic film is constituted of the thermoplastic elastomer material and has a plurality of penetrating air vents aligned or misaligned with the air vents of the unidirectional elastic cloth.

6. The bidirectional elastic air-permeable material according to claim 5, wherein the another bidirectional elastic film has an air permeability of 17-25 cc/sec per square centimeter.
